(19) United States
(12) Patent Application Publication
(10) Pub. No.: US 2004/0218746 A1
(43) Pub. Date: Nov. 4, 2004

(54) Process for switching telephone conversations

(76) Inventor: Omer Kaan Varol, Dusseldorf (DE)

Correspondence Address: Cantor Colburn LLP, 55 Griffin Road South, Bloomfield, CT, 06002, US

(21) Appl. No.: 10/681,956

(22) Filed: Oct. 8, 2003

(30) Foreign Application Priority Data
Apr. 30, 2003 (EP) 03009901.4

(51) Int. Cl. H04M 3/42; H04M 15/00

(52) U.S. Cl. 379/211.01; 379/114.21

(57) ABSTRACT

The disclosure pertains to a process for switching telephone conversations that are to be paid for by the recipient. In order to provide a process that is less cost intensive and thus economical while simultaneously largely avoiding errors at the time of switching the conversation, the invention proposes a process in which the telephone number of the call recipient is transmitted to a switching system by the caller, and the telephone number is checked in terms of its validity in a databank adjustment unit, and then, following prior authorization by the call recipient, a telecommunications connection is automatically established between the caller and the call recipient.

The invention pertains to a process for switching telephone conversations that are to be paid for from the recipient's side.

The special feature of telephone conversations that are to be paid for from the recipient's side, i.e. so-called “call-collect” conversations is that it is not the caller but, rather, the call recipient who accepts the costs as a consequence of the telephone conversation. In order to ensure that costs do not arise is an unjustified manner on the recipient's side, the call recipient is asked to declare his consent in regard to accepting the costs prior to establishing a telecommunications connection between the caller and the call recipient. If such a declaration is not forthcoming from the call recipient, then a note is made of this on the side of the telecommunication company that is conducting operations, and a telecommunications connection between the caller and the call recipient is not established.

In order to mediate telephone conversations that are to be paid for from the recipient's side, use is made, in accordance with the prior art, of switching personnel that are termed operators who, at the request of the caller, establish a connection with the call recipient and, following his/her consent, ask the call recipient to accept the costs that are to be expected as a result of conducting the telephone conversation. If the call recipient refuses to accept the costs, then the caller is notified of this by the switching personnel, and the caller's desired connection to the call recipient is not made by the switching personnel. Should the call recipient agree to accept the costs, then an appropriate telecommunications connection between the caller and the call recipient is established by the switching personnel. A conversation between the caller and the call recipient can then be conducted without further intervention from the switching personnel, whereby the costs that arise as a result of this are billed to the call recipient.

The switching process that has been described above is known from the prior art, and has proven valuable in everyday practical use. However, the high switching costs and the erroneous connections, which are caused by the manual establishment of a connection, are disadvantageous features and these lead, in particular, to dissatisfaction by the caller or the call recipient.

On the one hand, the high switching costs are explained in terms of the switching personnel that are, of necessity, required and, on the other hand, they are explained by the cost of equipping, maintaining, and servicing the places of work that are used by the switching personnel. In accordance with the prior art, the caller calls the switchboard, which is manned by the switching personnel, in order to mediate a telephone conversation that is to be paid for from the recipient's side. This can take place, for example, by selecting the number “0”. An available mediator, the so-called operator, is assigned to the caller in accordance with the principle of chance. The operator asks the caller for the telephone number of the call recipient, and then he/she calls the telephone number that has been communicated to him/her; he/she asks the call recipient for his/her consent in regard to accepting the costs in the event that the call is accepted. If the call recipient confirms this, the operator establishes a telecommunications connection between the caller and the call recipient. If confirmation is not forthcoming from the call recipient, or if he/she does not accept the call after the call has been placed by the operator, then the caller is notified of this, and the establishment of a conversation between the caller and the call recipient does not take place.

The manual switching process that is to be carried out by the operator is disadvantageously costly economically not only in terms of the costs that are due to the time involved, but also in terms of personnel costs. Overall, therefore, comparatively high costs arise merely as a result of switching the conversation. In addition, errors can arise during the switching of the conversation as a consequence, for example, of comprehension difficulties between the caller/call recipient on the one hand, and the operator on the other hand.

Proceeding from the prior art that has been described above, the objective of the invention is therefore to indicate a process for switching telephone conversations that are to be paid by the recipient, whereby this process is less cost intensive and thus more economical while simultaneously largely avoiding errors during switching the conversation.

In order to solve this problem, the invention proposes a process for switching telephone conversations, which are to be paid for by the recipient, whereby the telephone number of the call recipient is transmitted to a switching system by the caller, and the telephone number is checked in terms of its validity in a databank cross-checking arrangement, and then, following prior authorization by the call recipient, a telecommunications connection is automatically established between the caller and the call recipient.

Thus, in accordance with the invention, and in distinction from the prior art, conversation switching takes place fully automatically so that the use of switching personnel is not required. A computer-controlled switching system is provided for this purpose to which the caller communicates the telephone number of the call recipient. The telephone number of the call recipient is entered via the selection keyboard of the telephone apparatus that is provided on the caller's side so that, in the event of its being entered correctly by the caller, switching errors can be eliminated. The telephone number communicated to the switching system in this way is first checked for validity in a databank-adjusting unit. The extent of such checking can comprise e.g. the telephone number transmitted by the caller as such. This means that, in a first step, a check is initially made by the system of whether the telephone number indicated by the caller actually exists. Depending on the information status of the databank, a check can moreover be made of whether the telephone number, which has been recognized as being in existence, has been blocked under certain circumstances, or whether any as yet unpaid bills are in existence for the indicated telephone number, or whether the telephone number is incapable of being selected within the framework of a collect-call conversation. In addition to this, further checking criteria are possible as needed depending on which detailed items of information have been stored in the databank used for checking validity.

After the validity check of the telephone number has been successfully carried out, the call recipient is automatically called by the switching system and notified of the cost consequences of accepting the telephone conversation. If the call recipient consents in regard to accepting the costs of the telephone conversation, then the switching system automatically establishes a telecommunications connection between the caller and the call recipient so that they can now conduct the telephone conversation that is desired by the caller. The costs that arise as a consequence of this telephone conversation are billed to the call recipient.

Should the call recipient not agree to accept the costs, then the caller is notified of this by the switching system, and a telecommunications connection between the caller and the call recipient is not established on the part of the switching system.

This fully automatic switching of a telephone conversation, as distinct from prior art, advantageously permits the comparatively rapid establishment of a connection on the one hand, and, on the other hand, a significantly reduced error rate arises because switching of the conversation takes place exclusively on the basis of the telephone number that is entered by the caller himself. In addition to this, the process in accordance with the invention is very much less cost intensive because personnel costs can be saved, in particular, since it is no longer necessary to utilize switching personnel for conversation switching purposes.

It is provided n accordance with a special feature of the invention that the switching system is dialed by the caller, whereby the telephone number of the call recipient is simultaneously transmitted to the switching system at the time that the switching system is dialed. For this purpose, it is provided in accordance with the invention that the caller uses a multiple digit telephone number in order to call the switching system, whereby this multiple digit telephone number consists, on the one hand, of the number for calling the switching system and, on the other hand, the telephone number of the call recipient. It can be provided, for example, that the telephone number for calling the switching system is a multiple digit numerical code that has a defined number of integers. The call recipient's telephone number is appended to this numerical code, whereby the call recipient's telephone number is formed, for example, from the area code and phone number of the call recipient. The call recipient's telephone number, which is appended to the numerical code, is automatically recognized by the switching system, so that the call recipient's telephone number, which is to be called subsequently, is already known to the switching system when being called by the caller.

After the caller has called the switching system, status checking of the call recipient can then be carried out by means of the call recipient's already known telephone number. That is, a check can be made by the switching system as to whether the call recipient's line is busy or not. Should this check result in the finding that the call recipient's line is busy, then this is automatically communicated to the caller, and the connection between the caller and the switching system is automatically broken off. The conversation is thereby terminated.

Should this status check of the call recipient result in finding that the call recipient's line is not busy, then a validity check takes place in a databank-adjusting unit. At the same time, the caller receives a signal—by activation of the ring-back system—that the call recipient's line is not busy. After finalizing the validity check of the telephone number, a connection to the call recipient is established.

If, following a validity check of the telephone number that is indicated by the caller, the situation should arise that this number does not exist, or is blocked, or is otherwise inaccessible for a telephone conversation that is to be paid for from the recipient's side, then the caller is, likewise, automatically notified of this by the switching system. For this purpose, appropriate announcements, which are preferably in digital form, are available to the switching system that can administer and play back these announcements in accordance with requirements.

If, however, the checking of the telephone number is carried out with a successful result, then a telecommunications connection is established between the caller on the one hand, and the call recipient on the other hand. If the call recipient does not accept the incoming telephone call to him/her, e.g. because of absence, then the caller is notified of this, and the connection between the caller and the call recipient is broken off.

If the call recipient accepts the incoming telephone call to him/her, then the switching system first notifies the caller and the call recipient of the upcoming switching of the telephone conversation that is to be paid for by the recipient. In this connection, the switching system requests the caller—e.g. subsequent to an acoustic signal that is transmitted by the switching system—to make known an item of information that identifies him, preferably his name, whereby this preferably takes place via a spoken input. In addition, more detailed items of information can be transmitted to the caller in regard to usage, the provision of assistance, etc. Meanwhile, the switching system informs the call recipient about the functional procedure for the telephone conversation, which is to be paid for by the recipient, as well as in regard to the applicable rate scale. The switching system then automatically establishes a telecommunications connection between the caller and the call recipient for a specifiable time interval, and the caller is now requested, by giving an appropriate signal, to make known the information which identifies him/her, preferably via a spoken input. This information is then forwarded directly to the call recipient via the telecommunications connection that has been established between the caller and the call recipient, so that the call recipient is informed about the person who is calling. The telecommunications connection between the caller and the call recipient is broken off again after the specifiable time interval.

Subsequently to this, the switching system now requests the caller to stay on the line while the switching system asks the call recipient for his/her consent in regard to accepting the costs of the telephone conversation. In the event of positive confirmation by the call recipient, a telecommunications connection is established once again between the caller and the call recipient so that the telephone conversation can now be conducted. Should the call recipient not agree to accept the costs, then this is communicated to the caller, and the connection of the caller to the switching system is broken off, on the one hand, as is also, on the other, the connection of the switching system to the call recipient. The conversation is thereby terminated.

As distinct from the process known from the state of the art, the process in accordance with the invention is thus not only capable of being carried out fully automatically but, in addition, the caller already transmits the telephone number of the call recipient when calling the switching system. Advantageously, therefore, time-consuming communication between the caller and the switching system no longer takes place. In this way, not only can the switching time between the caller and the call recipient be shortened, but a reduction in costs also arises thereby because the costs for switching the connection between the caller and the switching system are at the expense of the network operating company.

In addition, it is an advantage that the item of information, which is to be transmitted to the call recipient to identify the caller, is not conveyed via the switching system but, rather, via a telecommunications connection that is established directly, on a temporary basis, between the caller and the call recipient. The load for the switching system is hereby alleviated, which can undertake only a limited number of switching services at the same time. In the event of authorization of the telephone conversation by the call recipient, moreover, the establishment of the telecommunications connection between the caller and the call recipient, which took place in order to transmit the information identifying the caller, can also be billed. In this way, an additional cost reduction for the operating company, which provides the switching system, can be achieved at the expense of the call recipient.

In accordance with an alternative proposal of the invention, it is provided that the switching system is dialed by the caller and the telephone number of the call recipient is transmitted to the switching system only after establishing a connection between the switching system and the caller. It is provided in accordance with this embodiment of the invention that the caller first dials the switching system via an appropriate telephone number. Such a telephone number can be formulated as a service telephone number by the telecommunications company providing switching which can be called free of charge by the caller. As soon as the telecommunications connection has been established between the caller and the switching system, the switching system requests the caller to state the telephone number of the call recipient that is wanted by him. This can take place, for example, by means of an input via the terminal unit that is used by the caller, or via a spoken input as well. Additional information regarding usage, providing assistance, etc. can also be transmitted to the caller.

In order for the call recipient to identify the caller, the switching system also requests that caller-identifying information, be transmitted to the switching system.

The switching system automatically calls the call recipient as soon as the telephone number of the call recipient and the caller-identifying information are known to the switching system. To the extent the latter accepts the telephone call, then the switching system communicates the caller-identifying information to him/her, e.g. the name of the caller, and the call recipient is notified by the switching system of the fact that, after authorization by him/her, the costs of the telephone conversation to be conducted between him and the caller, are at his expense. The switching system then provides the call recipient with an opportunity, by means of a keyboard entry on the telephone or via a spoken input, to give his/her consent in regard to accepting the costs. If the call recipient gives his consent, then a telecommunications connection is automatically established between the caller and the call recipient. If a statement of consent by the call recipient is lacking, then a telecommunications connection between the caller and the call recipient is not established, and the switching system notifies the caller of the withholding of consent by the call recipient.

The switching of the telephone conversation, which is to be paid for on the part of the recipient, is preferably free of charge both for the caller and for the call recipient. The costs, which are to be accepted by the call recipient, arise only after the establishment of the telecommunications connection between the caller and the call recipient that has been authorized by the call recipient. Thus, for exact billing purposes, the point in time of the establishment of the telecommunications connection between the caller and the call recipient is recorded by the switching system, and the time through to the end of the telecommunications connection is timed. The time period that results from this—in combination with the scale of charges that is applicable to the telephone conversation—results in the charges that are to be paid by the call recipient. The feature is hereby provided in accordance with the invention that the charges that are to be paid are automatically calculated by the switching system and billed to the call recipient. The automatically calculated amount of the bill can also be stored in the databank of the switching system in order, in this way, to be able to define a possible exclusion criterion at the time of the validity checking that has been described above. This could arise, for example, when the call recipient does not comply with settlement of bills that are as yet unpaid, so that the telephone number of the call recipient remains blocked for the switching of telephone conversations, which are to be paid by the recipient until yet unpaid bills have been paid. Thus receipt of payment is preferably to be stored in the databank of the switching system as well.

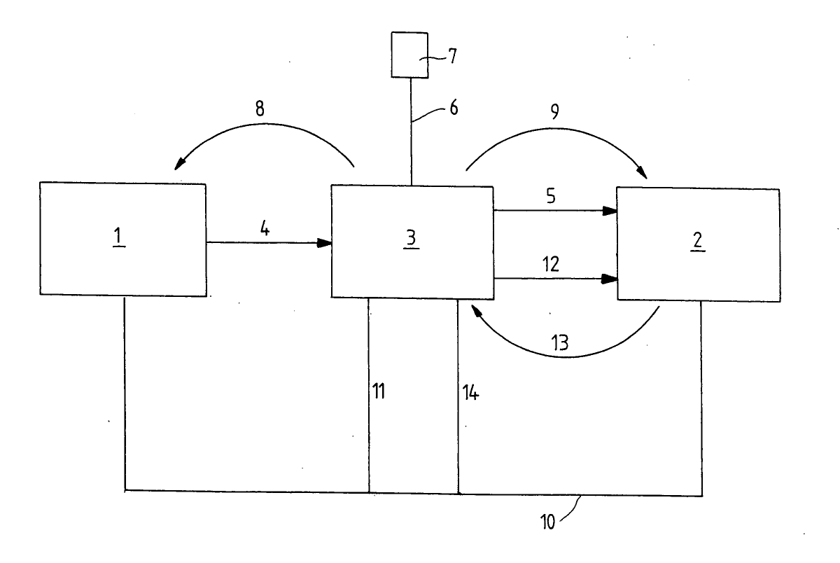

Additional features and advantages of the invention will emerge from the following description on the basis of FIG. 1 that shows the course of the process in accordance with the invention in the form of a schematic representation.

The caller 1, the call recipient 2, and the switching system 3 are represented schematically in FIG. 1. The caller 1 and the call recipient 2 are connected in a telecommunications sense via the line 10, whereby the establishment of the connection along this line takes place in accordance with the invention as described below.

In accordance with a first step in the process, the switching system 3 is dialed by the caller 1. This is illustrated symbolically in FIG. 1 by the arrow marked 4. A multiple digit telephone number serves for calling the switching system 3, whereby this telephone number is composed of the number to be called for the switching system 3 on the one hand, and the telephone number of the call recipient 2 on the other hand. The combination of numbers available for dialing the switching system 3 is defined in such a way in regard to its digits that the switching system can unambiguously identify the call recipient's telephone number that is appended to the number that is to be called for the switching system 3. The telephone number of the call recipient is already communicated to the switching system 3 as a resulting of its being called by the caller 1.

A status check of the call recipient is carried out on the basis of the call recipient's telephone number that is known to the switching system 3, i.e. a check is made automatically by the switching system 3 of whether the call recipient's line is busy or not. This status checking procedure is characterized in FIG. 1 by means of the arrow designated 5. While the call recipient's status is being checked, the telephone number of the call recipient is checked in terms of its validity in a databank-adjusting unit. For this purpose, the switching system 3 is connected by telecommunications to a databank 7 via a phone line. The checking of the validity of the call recipient's telephone number comprises at least checking the existence of the telephone number but, in addition to this, it can also involve further process steps such as e.g. subsequently checking whether the basically existing telephone number is blocked, or whether the subscriber having this telephone number has as yet unpaid bills.

After checking of the telephone number is concluded by the switching system, the switching system 3 informs the caller 1 that, in order to identify him, he has to state his name after e.g. an acoustic signal has been sounded. This switching of information is symbolized in FIG. 1 by means of the arrow designated 8. While giving instructions to the caller 1, the switching system notifies the call recipient, in accordance with the communication arrow 9, of the telephone conversation that is awaiting switching. In addition to this, the call recipient receives items of information regarding the rate scale pertaining to the telephone conversation, which is to be paid for by him, in the event of successful switching of the conversation.

As soon as the caller 1 and the call recipient 2 have been notified in accordance with the communication arrows 8 and 9, the switching system 3 establishes the telecommunications connection 10 between the caller 1 and the call recipient 2 for a specifiable period of time. This establishment of a connection is symbolized by the arrow designated 11 in FIG. 1. An acoustic signal, which is perceptible at least by the caller 1, is sounded together with the establishment of the telecommunications connection 10, whereby this acoustic signal indicates to him/her that he/she now has to pronounce his/her name loudly and clearly. The time interval, which the switching system 3 provides for this, can be restricted to 1 to 2 seconds. This name designation input, which took place from the side of the caller 1, is transmitted directly to the call recipient 2 via the telecommunications connection 10. In this way, the call recipient is informed in regard to the identity of the person who is the caller 1. The telecommunications connection 10 between the caller 1 and the call recipient 1 is broken off again after the predefined time interval, so that further communication between the caller 1 and the call recipient 2 is no longer possible.

In order to ensure that the item of information, which is to be provided by the caller for the purpose of identifying him as a person, is not used improperly for transmitting brief items of information to the call recipient, the feature is provided in accordance with the invention that the caller-identifying information is permitted to have only a certain length in terms of words or characters. For this purpose, it can be provided, for example, that the time, which is made available to the caller by the switching system for transmitting the item of information that identifies him, is restricted in terms of duration. For example, a time frame of 1 to 2 seconds can be provided in this regard. Caller-identifying information which cannot be communicated to the switching system within this time frame, is optionally either not forwarded to the call recipient at all, or it is forwarded to the call recipient only in regard to the information that is transmitted within this time frame. In addition, a corresponding entry can be made in the databank in the event that frequent violation of the time frame, which is made available for the transmission of information, is ascertained by the switching system, whereby this entry can also be used for blocking the telephone number of the call recipient or that of the caller.

In accordance with the communication arrow 9, the call recipient 2 is now asked for his consent in regard to accepting the charges. If the call recipient does not give his consent, then the conversation is terminated and the caller 1 is appropriately notified of this.

Should the call recipient 2 agree to accept the costs, then he has to declare his consent to the switching system 3, whereby this can take place, for example, via a spoken input or keyboard input on the apparatus on the call recipient's side. The declaration of consent by the call recipient 2 is symbolized by the arrow marked 13 in FIG. 1. During the consent request by the switching system 3, the caller 1 is put on hold and is optionally notified of the progress of the consent request. The telecommunications connection between the caller 1 and the call recipient 2 is established by the switching system 3 as soon as consent is given from the side of the call recipient 2, whereby this is illustrated symbolically by the arrow marked 14. The start of the establishment of the telecommunications connection 10 is registered by the switching system 3 so that it can ascertain the duration of the telephone conversation between the caller 1 and the call recipient 2. The establishment of the telecommunications connection 10, which took place in the prelude to the transmission of the name of the caller, is added to the total duration of the telephone conversation so that this can also be billed to the call recipient. The total duration of the conversation that results from this addition is automatically calculated by the switching system 3 and is computationally converted into the charge, which is to be paid by the call recipient, in accordance with the applicable rate scale.

1. Process for switching telephone conversations to be paid by a call recipient, the process comprising:
transmitting a telephone number of the call recipient to a switching system by a caller; and
checking the telephone number in terms of its validity in a databank adjustment unit; and
following prior authorization by the call recipient, automatically establishing a telecommunications connection between the caller and the call recipient.

2. Process in accordance with claim 1, wherein the switching system is dialed by the caller, and wherein the telephone number of the call recipient is transmitted to the switching system at the same time as the call to the switching system.

3. Process in accordance with claim 1, wherein a status check of the call recipient is carried out.

4. Process in accordance with claim 3, wherein, following successful status checking, a telecommunications connection is automatically established between the caller and the call recipient for a specifiable period of time.

5. Process in accordance with claim 1, wherein caller-identifying information is transmitted from the caller to the call recipient for the telecommunications connection between the caller and the call recipient.

6. Process in accordance with claim 1, wherein the telecommunications connection between the caller and the call recipient is automatically broken off following the transmission of the caller-identifying information and/or after a specifiable time interval.

7. Process in accordance with claim 1, wherein items of information pertaining to the rate scale are transmitted to the call recipient by the switching system.

8. Process in accordance with claim 1, wherein the switching system automatically asks the call recipient for authorization of the telephone call.

9. Process in accordance with claim 1, wherein in the absence of authorization by the call recipient, the switching system notifies the caller, and the telephone conversation is terminated.

10. Process in accordance with claim 1, wherein, after the telephone conversation has taken place, the charge that is to be paid in this regard is automatically calculated and billed to the call recipient.
